(19) United States
(12) Patent Application Publication
(10) Pub. No.: US 2009/0242140 A1
(43) Pub. Date: Oct. 1, 2009

(54) JACK MOUNTED TIRE BEAD BUSTER

(76) Inventor: Jeffrey O. Gates, Venice, FL (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/057,010

(22) Filed: Mar. 27, 2008

(51) Int. Cl. B60C 25/02

(52) U.S. Cl. 157/1; 157/1.3; 29/802; 29/426.1

(57) ABSTRACT

A tire removal tool for breaking the bead of the tire from the wheel rim is provided. The tool can include a bead member that is removably attachable to a distal end of a support member that is part of a trailer elevation jack. The elevation jack is rigidly attached to a trailer and has a jacking mechanism for retracting and extending the distal end of the support member. The bead member is dimensioned to fit adjacent to a rim and onto a tire bead, with the extension of the distal end of the support member resulting in pressure being applied down onto the tire bead. In this manner, the tire bead is separated from the wheel rim. The bead member can include a collar with an inlet end and a flange that is attached to the collar at a distance spaced apart from the inlet end. The inlet end is dimensioned to accept at least part of the distal end of the support member. In some instances, the collar has a rectangular shaped cross section, while in other instances the collar has a circular shaped cross section.

### FIELD OF THE INVENTION

This invention relates generally to a tool for facilitating the removal of a tire from a wheel rim, and in particular to a tool used with an elevation jack that is rigidly attached to a trailer to facilitate the removal of a tire from a wheel rim.

### BACKGROUND OF THE INVENTION

The removal of a pneumatic tire a wheel rim can be difficult. In particular, the tire has an annular tongue or annular strip around the inner periphery of the tire wall that is shaped for engaging the rim of the wheel. This annular region is typically known as the “bead” of the tire and can be difficult to remove or separate from the rim due to the stiffness of the tire wall. However, this initial step of “breaking” or “busting” the bead away from the rim is required before the bead can be pulled or pried over the rim and the tire subsequently removed therefrom.

Machines and tools that can be used to break the bead of a tire away from a wheel rim are known to those skilled in the art. However, most are designed for use within a shop environment and thus are impractical to take with an individual that is traveling on a trip, expected to participate in off-road vehicle activity and the like. In some instances, tools have been disclosed that can be attached to the jack of a motor vehicle that is typically used to elevate the vehicle in order to remove a flat tire. However, these tools require the assembly of the motor vehicle jack which can require the unloading or unpacking of a trunk that is full of luggage, equipment and the like. In addition, the assembly of the jack to the motor vehicle can result in very limited space under the motor vehicle jack where a tire is to be placed.

It is not uncommon for individuals to have a trailer attached to a motor vehicle when traveling, participating or watching off-road vehicle activity, going fishing and the like. These trailers can be used to carry off-road vehicles, a boat, luggage, etc. In addition, tires for off-road vehicles, the trailer, and/or the motor vehicle can experience flats or damage that requires the removal of the tire when access to a tire repair shop is not practical. Therefore, it would be desirable to have a tool that facilitates the breaking of the bead of a tire away from a wheel rim that could be used with a jack that is used for the trailer.

### SUMMARY OF THE INVENTION

A tire removal tool for breaking the bead of the tire from the wheel rim is provided. The tool can include a bead member that is removably attachable to a distal end of a support member that is part of a trailer elevation jack. The elevation jack is rigidly attached to a trailer and has a jacking mechanism for retracting and extending the distal end of the support member. The bead member is dimensioned to fit adjacent to a rim and onto a tire bead, with the extension of the distal end of the support member resulting in pressure being applied down onto the tire bead. In this manner, the tire bead is separated from the wheel rim.

The bead member can include a collar with an inlet end and a flange that is attached to the collar at a distance spaced apart from the inlet end. The inlet end is dimensioned to accept at least part of the distal end of the support member. In some instances, the collar has a rectangular shaped cross section, while in other instances the collar has a circular shaped cross section.

### BRIEF DESCRIPTION OF THE DRAWINGS

The present invention is further detailed with respect to the following drawings which depict exemplary, nonlimiting embodiments thereof.

FIG. 1 is a perspective view of an elevation jack rigidly attached to a trailer;

FIG. 2 is a perspective view of an embodiment of the present invention;

FIG. 3 illustrates the use of an embodiment of the present invention to break the bead of a tire away from a wheel rim;

FIG. 4 is a perspective view of a different embodiment of the present invention;

FIG. 5 is a perspective view of yet another embodiment of the present invention;

FIG. 6 is a perspective view of an elevation jack rigidly attached to a trailer;

FIG. 7 is a perspective view of an embodiment of the present invention;

FIG. 8 is a perspective view of an embodiment of the present invention; and

FIG. 9 is a perspective view of an embodiment of the present invention.

### DETAILED DESCRIPTION OF THE PRESENT INVENTION

The present invention discloses a tire removal tool that can be used to break the bead of a tire away from a wheel rim. As such, the tire removal tool has utility as a device for assisting in the changing of a tire.

The bead of a tire is known to be the annular tongue or annular strip that is around the inner periphery of a wall of a pneumatic tire that is shaped for engaging the rim of the wheel. “Breaking” the bead away from the wheel rim refers to causing the bead to move out of the trough or away from the flange of the rim and is necessary before the bead can be pulled or pried over the rim and the tire removed therefrom. The tire removal tool disclosed herein assists in breaking the bead of a tire away from the wheel rim by using a bead member that can be removably attached to a trailer jack.

The bead member can be removably attachable to a distal end of a support member, the support member being a leg or post of an elevation jack that is rigidly attached to a trailer. In some instances, the trailer is attached to a motor vehicle using a hitch, however this is not required. In addition, the bead member can be removably attachable to an elevation jack that is rigidly attached to a forward end of the trailer, to a trailer tongue of the trailer, to a rearward end of the trailer and the like. In other words, the location of the elevation jack with respect to the trailer is not critical and does not limit the scope of the tire removal tool disclosed herein.

The bead member can have a collar with an inlet end and a flange that is attached to the collar at a distance spaced apart from the inlet end. The inlet end of the collar is dimensioned to accept at least part of the distal end of the elevation jack support member. It is appreciated that the elevation jack can include a jacking mechanism for retracting and extending the distal end of the support member and that the retraction and extension is typically used to lower, raise and/or stabilize the trailer. In some instances, the collar of the bead member has a rectangular shaped cross section and in other instances the collar has a circular shaped cross section. It is appreciated that the term “rectangular shaped” includes square shaped cross sections also.

The distal end of the elevation jack support member can have an aperture through which a pin can be inserted therethrough. In these instances, the collar of the bead member can also include an aperture that allows for the alignment of the collar and distal end apertures and affords for a pin to be placed therethrough. In this manner, the bead member can be attached to the distal end of the elevation jack support member.

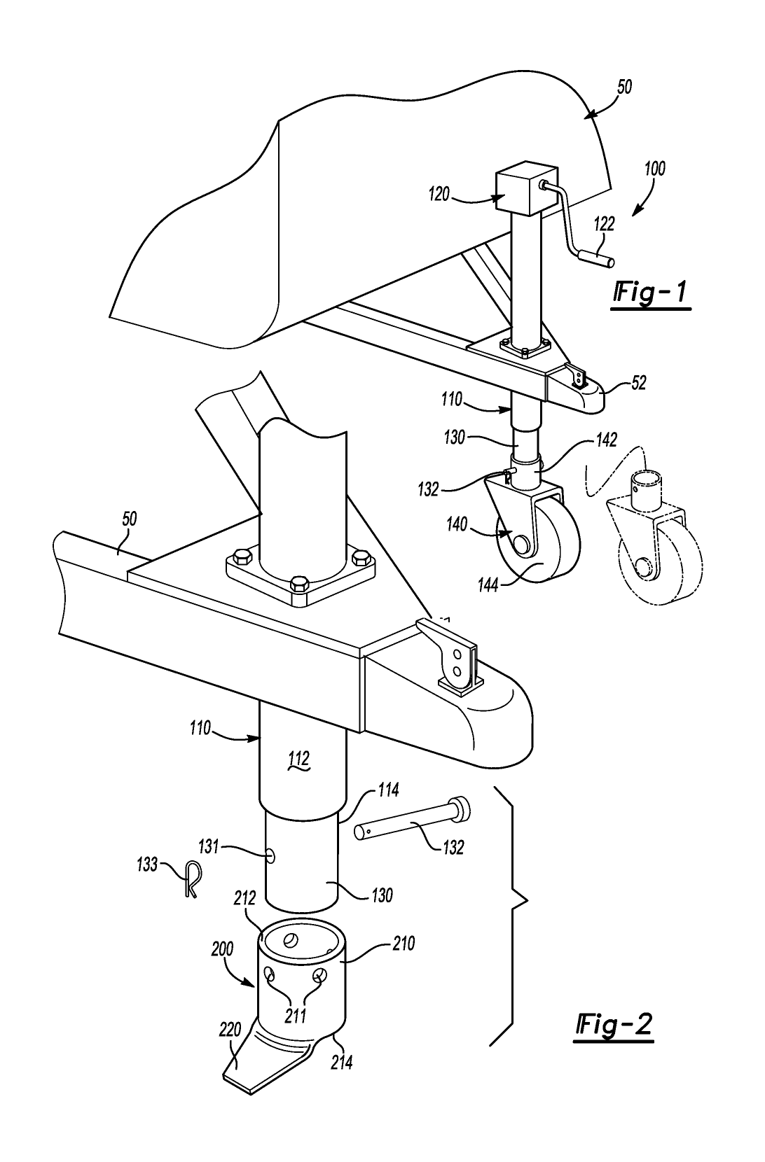

Turning now to FIG. 1, an elevation jack 100 is shown rigidly attached to a trailer 50. The elevation jack 100 can include a support member 110, a jacking mechanism 120 and a foot 140. The support leg 110 can have a distal end 130 that is spaced apart from the jacking mechanism 120. The jacking mechanism 120 can have a handle 122 which can be grasped by an individual and used to retract and extend the distal end 130 relative to the trailer 50. In some instances a lever can be used to “jack” the distal end 130 relative to the trailer 50 or a powered motor can be used to extend or retract the distal end 130. The trailer 50 can include a hitch 52 that affords for attachment of the trailer 50 to a motor vehicle, however this is not required. In some instances, the foot 140 can be in the form of a rolling mechanism that includes a wheel 144 and a collar 142 that accepts at least part of the distal end 130 of the trailer support member 110.

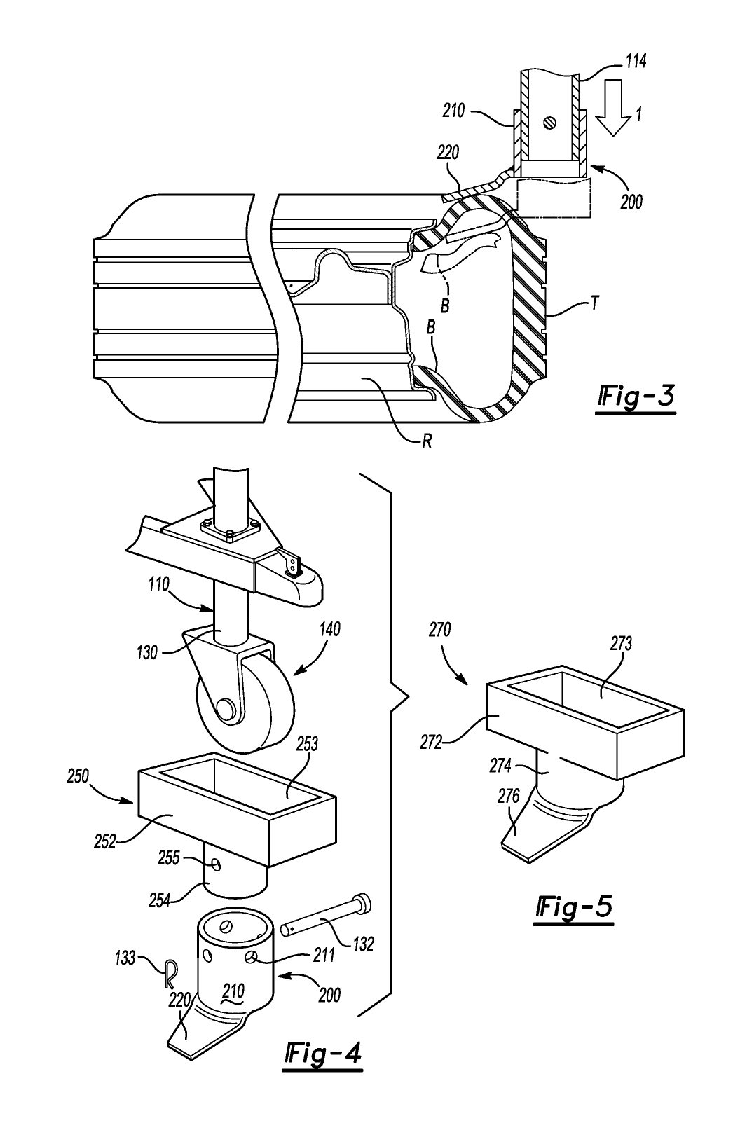

A bead member 200 is shown in FIG. 2, the bead member 200 operable to attach to the support member 110 after the foot 140 has been removed therefrom. As shown in this figure, the support member 110 can include a pair of telescoping tubes 112 and 114. The telescoping tube 114 can include an aperture 131 through which a pin 132 can slide therein. An attachment device 133 can be used to prevent the pin 132 from sliding out from the aperture 131. The bead member 200 can include a collar 210, the collar 210 having an inlet end 212 and a distal end 214. The collar 210 is dimensioned such that it will accept at least part of the distal end 130 of the trailer support member 110. In addition, the collar 210 can include an aperture 211, and in some instances a pair of apertures 211 that are dimensioned and located such that alignment with the aperture 131 is afforded. Once alignment of the aperture 211 with the aperture 131 has occurred, the pin 132 can be inserted therethrough and the bead member 200 thereby attached to the trailer support member 110. Extending from the collar 210 is a flange 220, the flange being spaced apart from the inlet end 212. It is appreciated that the flange 220 can be placed adjacent to a rim R and on top of the sidewall of a tire T as illustrated in FIG. 3. As shown in this figure, a tire that is laid horizontally upon a base surface can be placed underneath the tool 200 and the flange 220 brought into contact with the tire by extending the distal end 130 of the trailer support member 110 in a generally downward direction 1 using the jacking mechanism 120. Once the flange 220 has been placed adjacent to the rim R and the distal end is extended using the jacking mechanism 120, pressure is applied to the sidewall of the tire T and the bead B is separated away from the rim R. In this manner, the bead B is broken away from the rim R and removal of the tire T from the wheel rim R is facilitated. It is appreciated that once the bead B is broken away from the wheel rim R, the tool 200 can be retracted away from the tire using the elevation jack 100. Thereafter, the tire can be removed out from under the tool 200 and using appropriate tools the bead B of the tire T pulled over the rim R, thus allowing the removal of the tire T.

Another embodiment of the tire removal tool is shown in FIG. 4. In this embodiment, the removal of the foot 140 from the distal end 130 of the trailer support member 110 is not required. The tire removal tool 200 can be attached to the distal end 130 using an adapter 250. The adapter 250 has a sidewall 252 that affords for an inner volume or cavity 253 within which the foot 140 fits at least partially therein. The adapter 250 furthermore has a tube 254 that can fit at least partially within collar 210 or partially over collar 210 such that an aperture 255 aligns with apertures 211 and pin 132 can slide therethrough and result in attachment of the tool 200 to the adapter 250. Thereafter, the adapter 250 can be placed in contact with the foot 140 and the tool 200 used as described above.

Turning now to FIG. 5, a similar use of a tire removal tool is shown, however in this embodiment a tool 270 is illustrated with a sidewall 272 affording for an inner volume or cavity 273 which will accept at least part of the foot 140 shown in FIG. 4. In addition, the tool 270 has a tube 274 extending from sidewall 272, or from a bottom wall (not shown) that extends from the sidewall 270 and encloses the cavity 270. A flange 276 can extend from the tube 274 and be placed adjacent to the wheel rim R and used to break the bead B of the tire T away from the wheel rim R as described above. It is appreciated that with the embodiment shown in FIG. 5 the tool 270 is one unit.

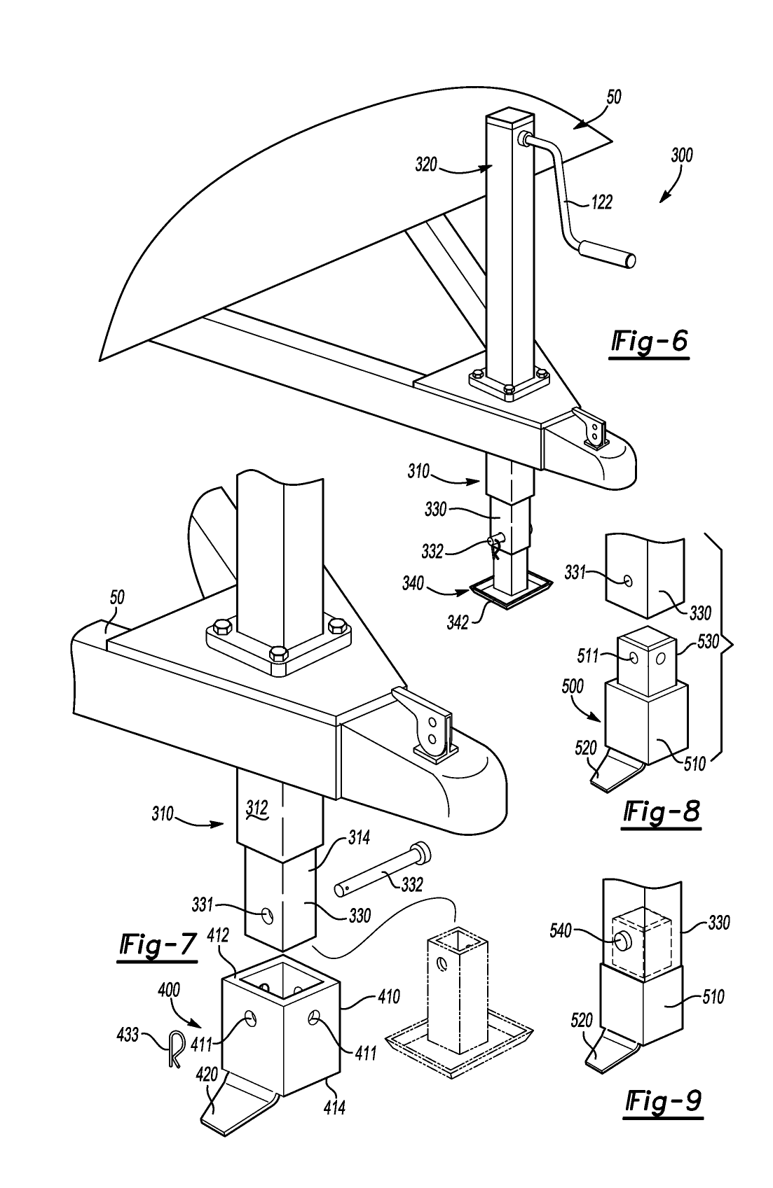

In some instances, the elevation jack of a trailer will not have a rolling mechanism. Such an elevation jack is shown generally at reference numeral 300 in FIG. 6. The jack 300 has a support leg 310, a jacking mechanism 320, a distal end 330 of the support leg 310 and a foot 340 attached thereto. As shown in this figure, the foot 340 does not have a rolling mechanism but instead has a pad 342. If such an elevation jack is rigidly attached to the trailer 50, the embodiment shown in FIGS. 7-9 can be used to assist in the removal of the tire T from the wheel rim R. In particular, FIG. 7 illustrates a tire removal tool 400 that can be attached to the support leg 310 once the foot 340 has been removed therefrom. Similar to the embodiment illustrated in FIG. 2, the tool 400 has a collar 410, the collar 410 having an inlet end 412 and a distal end 414. The collar can include an aperture 411 or a pair of apertures 411 that can be aligned with an aperture 331 that is located at the distal end 330 of the trailer support leg 310. Once the apertures have been aligned, the pin 322 can be inserted therethrough and in this manner the tool 400 attached to the support leg 310. It is appreciated that the distal end 320 can be extended and retracted using the jacking mechanism 320 and that the support leg 310 can include a pair of telescoping tubes 312 and 314. Once the collar 410 has at least partially accepted the distal end 330, the flange 420 of the tool 400 can be used to break the bead B of the tire T.

Turning now to FIG. 8, another embodiment of the tool is shown generally at reference numeral 500 wherein a shaft 530 can be at least partially inserted within the distal end 330 of the support leg 310. The tool 500 can include an extension 510 extending away from the shaft 530 and a flange 520 extending away from the extension 510. In this embodiment, the shaft 530 has an aperture 511 that can be aligned with the aperture 331, thereby affording for the pin 322 to be placed therethrough. In this manner, the tool 500 can be attached to the distal end 330 of the trailer support leg 310. In some instances, the shaft 530 can have a spring-loaded tab 540 as shown in FIG. 9, the tab 540 being dimensioned and located such that its alignment with the aperture 331 of the distal end 330 affords for attachment of the tool 500 to the support leg 310.

In operation, a tire that has been removed from an off-road vehicle, a boat trailer and the like can be laid flat on the ground. The foot of a jacking mechanism that is rigidly attached to a trailer can be removed and the tire removal tool disclosed herein can be attached to a distal end of a support leg for the jack. Once the tire removal tool has been attached to the distal end, the tire can be placed underneath the tool and the flange can be placed adjacent to the wheel rim and onto the sidewall of the tire. The jacking mechanism of the elevation jack can then be used to extend the tire removal tool in a generally downward direction and apply pressure onto the sidewall and/or bead of the tire until it is separated away from the wheel rim. Once the bead has been broken away from the wheel rim, the tire removal tool can be retracted using the jacking mechanism and the tire removed from the rim.

It is to be understood that various modifications are readily made to the embodiments of the present invention described herein without departing from the scope and spirit thereof. Accordingly, it is to be understood that the invention is not to be limited by the specific illustrated embodiment, but by the scope of the appended claims.

I claim:

1. A tire removal tool comprising:
an elevation jack rigidly attached to a trailer, said elevation jack having a support member and jacking mechanism for retracting and extending a distal end of said support member;
a bead member removably attachable to said distal end of said support member, said bead member dimensioned to fit adjacent to a rim and onto a tire bead.

2. The tire removal tool of claim 1, wherein said elevation jack is rigidly attached to a forward end of the trailer.

3. The tire removal tool of claim 2, wherein said elevation jack is rigidly attached to a trailer tongue of the trailer.

4. The tire removal tool of claim 1, wherein said bead member has a collar with an inlet end and a flange attached to said collar at a distance spaced apart from said inlet end, said collar inlet end dimensioned to accept at least part of said distal end of said support member.

5. The tire removal tool of claim 4, wherein said collar has a rectangular shaped cross section.

6. The tire removal tool of claim 4, wherein said collar has a circular shaped cross section.

7. The tire removal tool of claim 4, wherein said collar and said distal end of said support member each have an aperture, said apertures dimensioned and located to align when said distal end is accepted into said collar.

8. The tire removal tool of claim 7, further comprising an attachment pin dimensioned to slide at last partially through said apertures in said collar and said distal end.

9. A tool for breaking the bead of a tire located on a rim using a trailer elevation jack, said tool comprising:
an elevation jack rigidly attached to a trailer, said elevation jack having a support member and a jacking mechanism for retracting and extending a distal end of said support member in a generally vertical direction;
a bead member having a collar with an inlet end dimensioned to accept at least part of said distal end and a flange attached to said collar at a distance spaced apart from said inlet end, said bead member removably attached to and extending from said distal end of said support member, said flange dimensioned to fit onto a tire bead that is adjacent to a rim.

10. The tool of claim 9, wherein said elevation jack is rigidly attached to a forward end of the trailer.

11. The tool of claim 10, wherein said elevation jack is rigidly attached to a trailer tongue of the trailer.

12. The tool of claim 9, wherein said collar and said distal end of said support member each have an aperture, said apertures dimensioned and located to align with each other when said distal end is accepted within said collar of said bead pushing member.

13. The tool of claim 12, further comprising an attachment pin, said attachment pin dimensioned to fit at least partially within said apertures of said collar and said distal end.

14. A method for breaking the bead on a tire located on a rim using a trailer elevation jack, the method comprising:
providing a trailer with a rigidly attached elevation jack, the elevation jack having a support member and jacking mechanism for retracting and extending a distal end of the support member in a generally vertical direction;
providing a bead member removably attached to the distal end of the support member, the bead member being spaced apart a distance from a base surface such that a tire on a rim can fit underneath;
providing a tire on a rim and placing the tire underneath the bead member;
extending the bead member using the jacking mechanism in a generally downward direction until bead member contacts a tire bead adjacent to the rim; and
further extending the bead member until the tire bead separates from the rim.

15. The method of claim 14, wherein the bead pushing member has a collar dimensioned to accept at least part of the distal end of the support member and a flange, the flange being attached to the collar.

16. The method of claim 15, wherein the collar has a rectangular shaped cross section.

17. The method of claim 15, wherein the collar has a circular shaped cross section.

18. The method of claim 15, wherein the collar and the distal end each have a sidewall.

19. The method of claim 18, wherein the collar sidewall and the distal end sidewall each have an aperture, the apertures being dimensioned and located such that the apertures align when the distal end is accepted into the collar.

20. The method of claim 19, further providing an attachment pin, the attachment pin dimensioned to slide at least partially through the apertures.

21. The method of claim 14, further providing a motor vehicle that the trailer is attached to.
